(19) United States
(12) Patent Application Publication
(10) Pub. No.: US 2026/0330938 A1
(43) Pub. Date: Oct. 22, 2026

(54) THEFT PREVENTION ENCLOSURE SYSTEM FOR AUTOMATED TELLER MACHINES

(71) Applicant: BCSI, Inc., Palmer, TX (US)

(72) Inventor: Andrew Spaniel, Palmer, TX (US)

(21) Appl. No.: 19/650,111

(22) Filed: Apr. 16, 2026

Related U.S. Application Data
(60) Provisional application No. 63/789,969, filed on Apr. 16, 2025.
(60) Provisional application No. 63/874,566, filed on Sep. 2, 2025.

(51) Int. Cl. G07F 19/00

(52) U.S. Cl. CPC G07F 19/205

(57) ABSTRACT

A theft prevention enclosure system may include a theft prevention structure defining a security region sized to receive an automated teller machine (ATM) therein; a sleeve disposed on the theft prevention structure; and a locking element. The sleeve and the theft prevention structure may together define an enclosed space that extends from the security region. The sleeve may be slidably engaged with the theft prevention structure such that movement of the sleeve relative to the theft prevention structure changes a volume of the enclosed space. The sleeve, when slidably positioned to be positioned against a wall of a structure behind the ATM, may limit or prevent access to a rear side of the ATM. The locking element may be configured to secure the sleeve in position with respect to the theft prevention structure.

### CROSS-REFERENCE TO RELATED APPLICATIONS

This application claims the benefit of and priority to U.S. Provisional Patent Application No. 63/789,969, filed Apr. 16, 2025, and U.S. Provisional Patent Application No. 63/874,566, filed Sep. 2, 2025, the entire contents of each of which are hereby incorporated by reference herein.

### BACKGROUND

An automated teller machine (ATM) is a self-service electronic banking device that allows users to perform financial transactions, such as withdrawing cash, depositing funds, and checking account balances, without the need for direct interaction with bank personnel.

Automated teller machines (ATMs) are frequently targeted for theft due to their accessibility and the large sums of cash they contain. Criminals often attempt to forcibly remove ATMs from locations in which they are installed, for example, using vehicles to transport the ATM to a remote location, where they can attempt to break into the ATM unimpeded.

### SUMMARY

To provide for secure mounting of an automated teller machine (ATM) within an environment, the principles provided herein include a theft prevention enclosure system, and method for installing the ATM into a building or another environment via the theft prevention enclosure system.

In an embodiment, the theft prevention enclosure system may include a theft prevention structure defining a security region sized to receive an automated teller machine (ATM) therein. A sleeve may be disposed on the theft prevention structure. A locking element may be used to lock the left prevention system. The theft prevention structure may include a base defining a base opening to enable a fastening member to extend through the base opening and into a floor on which the theft prevention structure is positioned. The sleeve and the theft prevention structure may together define an enclosed space that extends from the security region. The sleeve may be slidably engaged with the theft prevention structure such that movement of the sleeve relative to the theft prevention structure changes a volume of the enclosed space. The sleeve, when slidably positioned to be positioned against a wall of a structure behind the ATM, may limit or prevent access to a rear side of the ATM. The locking element may be configured to secure the sleeve in position with respect to the theft prevention structure.

Another embodiment relates to a theft prevention structure for an automated teller machine (ATM). The theft prevention structure includes: a base configured to support the ATM above a ground surface; a top wall, and a pair of side walls. The base may define at least one opening configured to receive a fastening member for anchoring the theft prevention structure to the ground surface or a rear wall. The pair of side walls may extend between the base and the top wall and may defining, with the base and the top wall, a security region sized to receive the ATM therein. The base may protrude from an outer edge of the pair of side walls along a longitudinal direction. At least one of the top wall and the pair of side walls may define a slot that extends along the longitudinal direction.

Another embodiment relates to a method of installing an automated teller machine. The method includes: positioning a housing at a wall such that an opening defined by the housing faces away from the wall; inserting the automated teller machine (ATM) through the opening and into an enclosed volume defined by the housing; securing the ATM and housing to a floor at which the ATM and housing are positioned; and moving a sleeve disposed over the housing relative to the housing such that the sleeve engages the wall to substantially enclose a region between the ATM and the wall, thereby limiting or preventing access to a rear side of the ATM.

### BRIEF DESCRIPTION OF THE FIGURES

A more complete understanding of the method and apparatus of the present invention may be obtained by reference to the following Detailed Description when taken in conjunction with the accompanying Drawings wherein:

FIGS. 1A-1C are illustrations of a front left perspective view, a side view, and a front right perspective view, respectively, of an illustrative automated teller machine (ATM) system that includes a theft prevention enclosure system engaged therewith;

FIG. 1D is a front perspective view of the illustrative theft prevention enclosure system of FIGS. 1A-1C;

FIG. 1E is an illustration of a top view of the illustrative theft prevention enclosure system of FIGS. 1A-1C;

FIG. 1F is an illustration of a side view of the illustrative theft prevention enclosure system of FIGS. 1A-1C;

FIG. 1G is an illustration of a rear view of the illustrative theft prevention enclosure system of FIGS. 1A-1C;

FIG. 1H is an illustration of a front view of the illustrative theft prevention enclosure system of FIGS. 1A-1C;

FIG. 1I is an illustration of a top view of a base of the illustrative theft prevention enclosure system of FIGS. 1A-1C;

FIG. 1J is an illustration of a front perspective view of an ATM-base interface of the illustrative theft prevention enclosure system of FIGS. 1A-1C;

FIG. 2A is an illustration of a front perspective view of an illustrative theft prevention enclosure system for an ATM;

FIG. 2B is an illustration of a side view of the illustrative theft prevention enclosure system of FIG. 2A;

FIGS. 2C-2I are illustrations of a front perspective view, a front view, a rear view, a first side view, a second side view, a top view, and a bottom view, respectively, of an illustrative enclosure assembly of the illustrative theft prevention enclosure system of FIG. 2A;

FIGS. 3A-3C are illustrations of a front perspective view, a front view, and a side perspective view, respectively, of another illustrative automated teller machine (ATM) system that includes a theft prevention enclosure system having an ATM retaining belt assembly;

FIG. 3D is an illustrative front perspective view of the illustrative theft prevention enclosure system of FIGS. 3A-3C, shown with the ATM retaining belt assembly in a locked position;

FIG. 3E is an illustrative side perspective view of the illustrative theft prevention enclosure system of FIGS. 3A-3C, shown with the ATM retaining belt assembly in an unlocked position;

FIG. 4A is an illustration of a front perspective view of an illustrative theft prevention enclosure system shown during a first installation operation;

FIG. 4B is an illustration of a front perspective view of the illustrative theft prevention enclosure system of FIG. 4A shown during a second installation operation;

FIG. 4C is an illustration of a top perspective view of the illustrative theft prevention enclosure system of FIG. 4A shown during a third installation operation;

FIG. 4D is an illustration of a front perspective view of the illustrative theft prevention enclosure system of FIG. 4C shown during the third installation operation;

FIG. 4E is an illustration of a front perspective view of the illustrative theft prevention enclosure system of FIG. 4A shown during a fourth installation operation;

FIG. 4F is an illustration of a side view of the illustrative theft prevention enclosure system of FIG. 4A shown during the fourth installation operation; and

FIG. 4G is an illustration of a top perspective view of the illustrative theft prevention enclosure system of FIG. 4A shown during the fourth installation operation.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Embodiments of the present disclosure relate to theft prevention enclosure systems designed to prevent theft of and/or tampering with automated teller machines (ATM). In an embodiment, the system includes a theft prevention structure (e.g., a housing) and a sleeve that is movably coupled to the theft prevention structure. The theft prevention structure may define an opening or security region sized to receive the ATM therein. The theft prevention structure and sleeve design allows the sleeve to be moved relative to the theft prevention structure to enclose a gap between the ATM and a wall behind the ATM, thereby enhancing security and preventing unauthorized access to a rear side of the ATM and/or to power and/or data connections between the ATM and a structure surrounding the ATM. The theft prevention enclosure system may be configured for securing ATMs in various locations, including gas stations and convenience stores, and/or other locations. The theft prevention enclosure system may be sized for any size and shape ATM. The theft prevention system may be primarily utilized to secure and prevent theft of indoor ATMs.

In an embodiment, the theft prevention structure anchors the ATM securely to a ground surface (e.g., a floor) of a structure (e.g., building, store, etc.) surrounding the ATM. In some embodiments, the theft prevention enclosure system may also be configured to secure the ATM in position in environments external to a building or other enclosure (e.g., outdoor installation locations), such as by anchoring the theft prevention structure and/or ATM to a ground surface. In some embodiments, the theft prevention structure defines multiple openings for fasteners (e.g., anchoring bolts, etc.), which can be used to secure the theft prevention structure and/or ATM to the floor. The theft prevention structure may include a base that is configured to space a frame portion of the theft prevention structure apart from the wall (e.g., by a distance of about 3 inches to about 5 inches, etc.) to define a space therebetween to accommodate cords and plugs for data and power connections, which typically cause the ATM to be positioned a few inches away from the wall. The space for the cords and plugs is often used by thieves to secure a chain for theft of the ATM.

The enclosure system also may include a cover trim (e.g., an outer trim piece, a front trim piece, etc.) that is configured to conceal at least a portion of the interface between the theft prevention structure and the ATM on a front side of the theft prevention structure. For example, the enclosure system may include a cover trim that conceals a gap region between the side walls of the ATM and the theft prevention structure and further prevents access to mechanical fasteners that secure the sleeve in position relative to the theft prevention structure. The cover trim may include magnets to detachably couple the cover trim to the theft prevention structure.

The system allows for easy access to the ATM's plugs and connections while maintaining a secure enclosure. During use, the sleeve can be moved forward or backward relative to the theft prevention structure to cover any gaps between the ATM and the surrounding structure, ensuring the ATM remains secure even if positioned further from the wall. The design may also include anti-theft features, such as concealed screws and bolts, that are internally accessible within the housing to loosen, thereby making it difficult for unauthorized individuals to tamper with the ATM.

The system may also include a retaining belt assembly (which may also be referred to as a strap assembly, a gate assembly, a secondary support element assembly, and/or a locking element assembly) that extends around and encompasses a removable service cover of the ATM. The retaining belt assembly is repositionable between a locked position and an unlocked position to facilitate access to the ATM cover to enable removal of the cover for adding cash and/or other service events. The retaining belt assembly may include a separate locking mechanism to secure the retaining belt structure in position over the service cover, and to secure the retaining belt structure in position relative to the housing of the theft prevention enclosure.

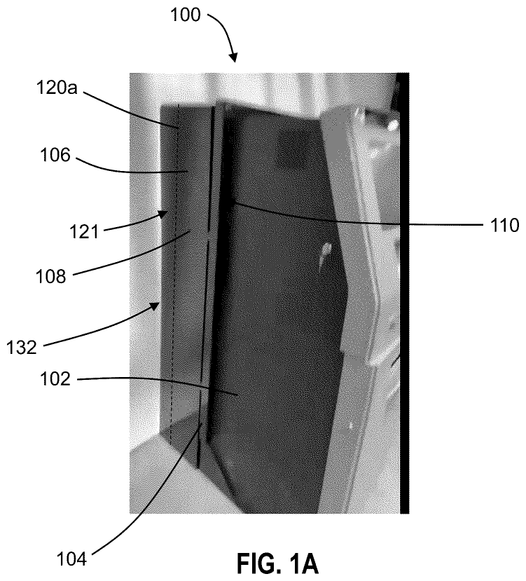

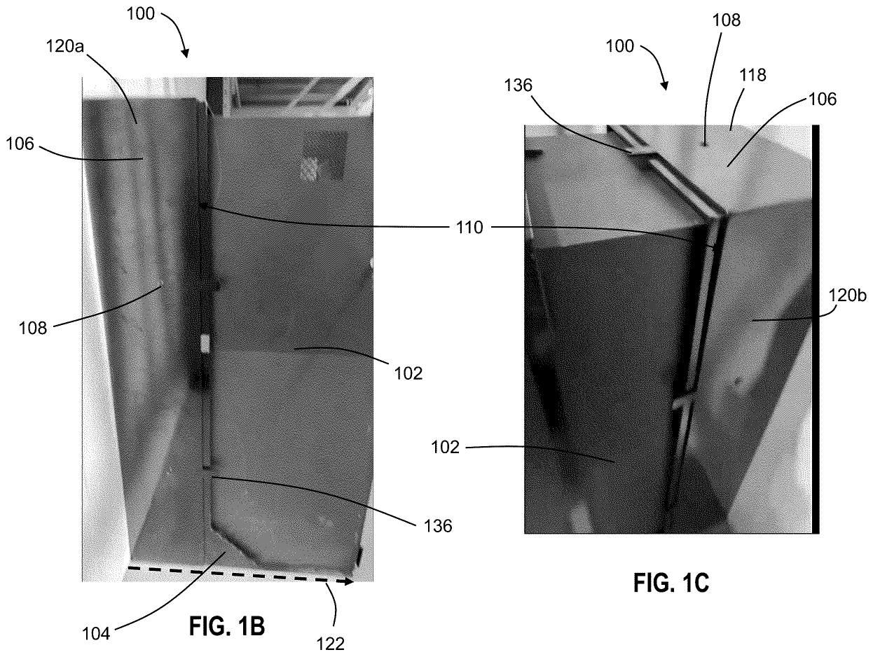

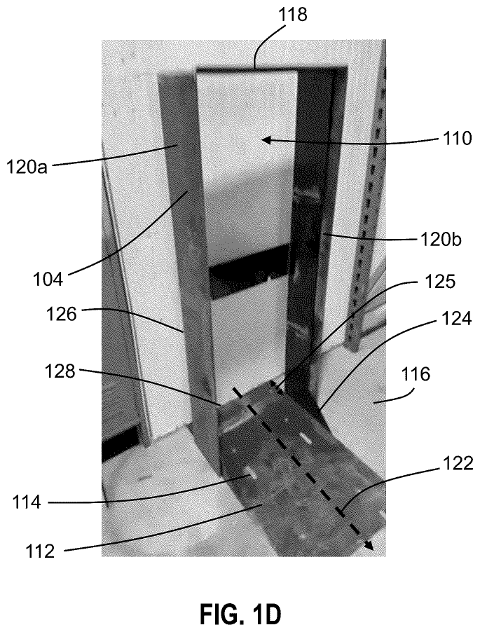

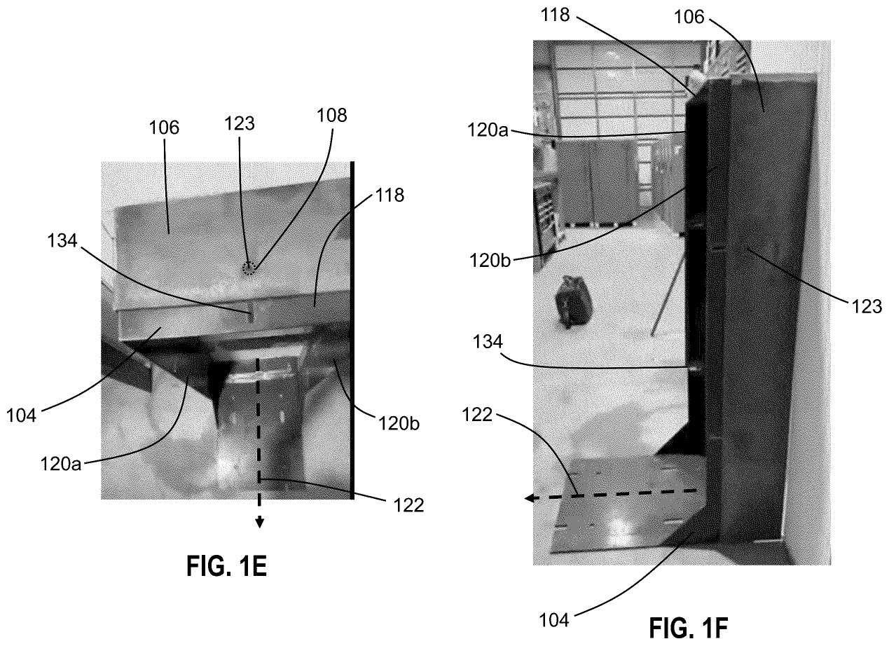

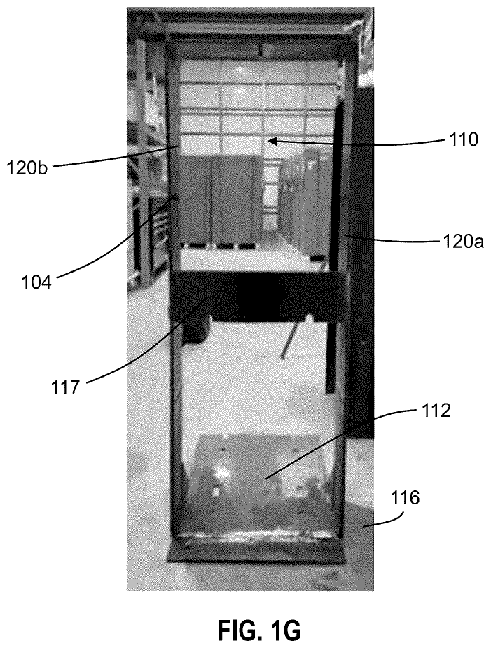

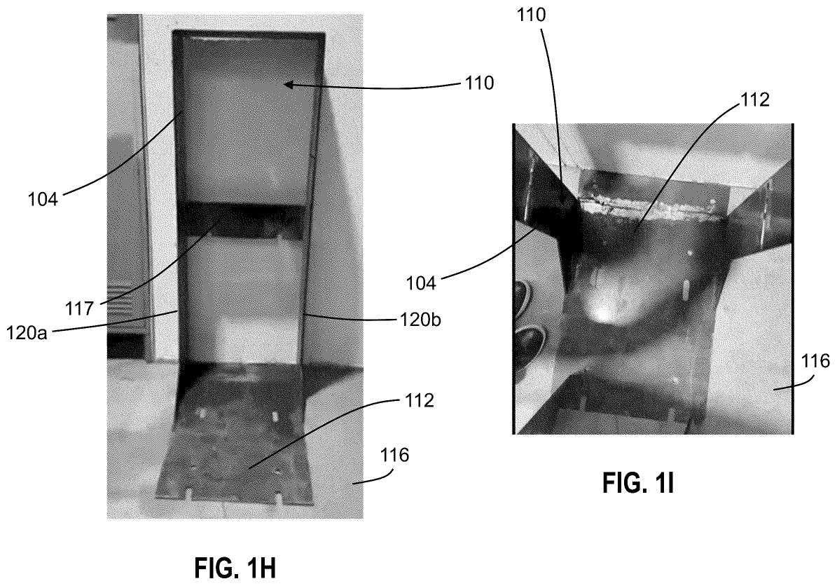

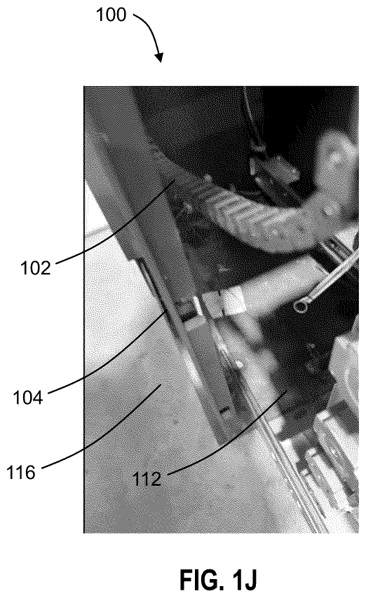

Referring to FIGS. 1A-1C, a theft prevention enclosure system 100 for an ATM 102 is shown, according to an embodiment. The theft prevention enclosure system 100 may include a theft prevention structure 104, a sleeve 106, and a locking element 108.

Referring to FIGS. 1D-1J, the theft prevention structure 104 is configured to secure the ATM 102 (see FIG. 1A) in position within an environment, such as within a gas station, a restaurant, a convenience store, a bank, or another indoor or outdoor location. In some embodiments, and as shown, the theft prevention structure 104 includes a housing that supports the ATM above a ground surface (e.g., a floor) of a building for water damage protection or otherwise.

Referring to FIG. 1D, the theft prevention structure 104 may include a base 112 defining at least one base opening 114 to enable a fastening member to extend through the base opening(s) 114 and into a floor 116 on which the theft prevention structure 104 is positioned. In some embodiments, and as shown, the base 112 is configured as a base wall and/or panel that separates the ATM from the floor 116.

The theft prevention structure 104 may define a security region 110 (e.g., an opening, an enclosed or partially enclosed region) sized to receive the ATM therein. In some embodiments, the theft prevention structure 104 further includes a top wall 118 and a pair of side walls 120a, 120b extending between the base 112 and the top wall 118. In some embodiments, the pair of side walls 120a, 120b are spaced apart from at least one end of the base 112, such that the base 112 protrudes from the pair of side walls 120a, 120b along a longitudinal direction 122 (e.g., a direction extending normal to a front face of the ATM 102).

In some embodiments, at least one sidewall of the pair of side walls 120a, 120b defines a support member 124 that extends at an angle (e.g., 45 degrees) from the at least one sidewall to the base 112.

In some embodiments, a distance 125 between a rear edge 126 of the pair of side walls 120a, 120b and a first longitudinal end 128 (e.g., a rear end) of the base 112 is sized to accommodate a power connection for the ATM when the ATM is coupled to the theft prevention structure 104.

Referring to FIGS. 1G-1I, the base 112 may define multiple openings (e.g., apertures, holes, slots, etc.) disposed beneath or behind the security region 110 that are configured to facilitate mounting the theft prevention structure 104 to the floor 116. In some embodiments, the base 112 is configured to secure the ATM at an intermediate position along the base 112, such that a rear end of the ATM is spaced apart from a longitudinal end of the base 112. Such an arrangement can provide clearance for cords and plugs behind the ATM 102 (see FIG. 1A).

Referring to FIGS. 1G-1H, the theft prevention structure 104 may include a support member, shown as a rear support panel 117, extending across the security region 110 at a first longitudinal end 128 (see also FIG. 1D) of the side walls 120a, 120b (e.g., extending from rear longitudinal edges of the side walls 120a, 120b about halfway between an upper and lower end of the side walls 120a, 120b). The rear support panel 117 may be configured to limit movement of the ATM 102 within the security region 110.

Referring to FIG. 1J, the enclosure system 100 may also include a mount, such as one or more bolts or other mechanical fasteners to secure the ATM 102 to the base 112 and/or to the floor 116. The mount may extend through a lower wall of the ATM 102, through the base opening 114, and into the floor 116.

In some embodiments, and as shown in FIGS. 1A-1C, the theft prevention structure 104 at least partially surrounds the ATM 102 when the ATM 102 is disposed within the security region 110. In some embodiments, and as shown, the theft prevention structure 104 (e.g., the base 112, the top wall 118, and the side walls 120a, 120b) circumscribes the ATM 102 and has substantially the same cross-sectional profile as the ATM 102. For example, the theft prevention structure 104 may have a rectangular cross-sectional profile when viewed normal to a front face of the ATM 102, which can further reduce the risk of tampering by reducing the size of gaps between the theft prevention structure 104 and the ATM 102. In other embodiments, the theft prevention structure 104 may have a different cross-sectional profile or shape.

The sleeve 106 is disposed on the theft prevention structure 104 and at least partially surrounds the theft prevention structure 104. In some embodiments, and as shown in FIGS. 1E-1F, the sleeve 106 is disposed over the theft prevention structure 104, such that the theft prevention structure 104 is positioned between the sleeve 106 and at least a portion of the ATM 102. Such an arrangement can simplify manual manipulation of a position of the sleeve 106 relative to the theft prevention structure 104 during installation.

The sleeve 106 is configured to extend along at least one side of the ATM 102 when the ATM 102 is positioned within the security region 110. The sleeve 106 may be movably coupled to the theft prevention structure 104 and may be configured to selectively conceal an area (e.g., an enclosed space) that extends rearward of the security region 110.

In some embodiments, the sleeve 106 extends across a single side of the theft prevention structure 104. In some embodiments, the sleeve 106 extends across at least three sides of the theft prevention structure 104, such as across the top wall 118 and the pair of side walls 120a, 120b. In such embodiments, the sleeve 106 may be substantially co-extensive with the top wall 118 and the pair of side walls 120a, 120b so that the sleeve 106 substantially covers any gap formed between (i) the top wall 118, the pair of side walls 120a, 120b, and (ii) a wall of the environment against which the theft prevention structure 104 is positioned. In some embodiments, where the sleeve 106 extends along the side walls, a height of the sleeve 106 may be approximately the same as a height of the theft prevention structure 104. The sleeve 106 is sized to substantially enclose an open region between the ATM 102 and the wall of the structure behind the ATM 102.

The sleeve 106 and the theft prevention structure 104 together define an enclosed space 121 that extends from the security region 110, such as rearward of the security region 110. The sleeve 106 may be slidably engaged with the theft prevention structure 104, such that movement of the sleeve 106 relative to the theft prevention structure 104 changes a volume of the enclosed space 121 (see FIG. 1A). In the embodiment of FIG. 1A, the sleeve 106, when slidably positioned against a wall of a structure behind the ATM 102, is configured to limit or prevent access to a rear side 132 of the ATM 102.

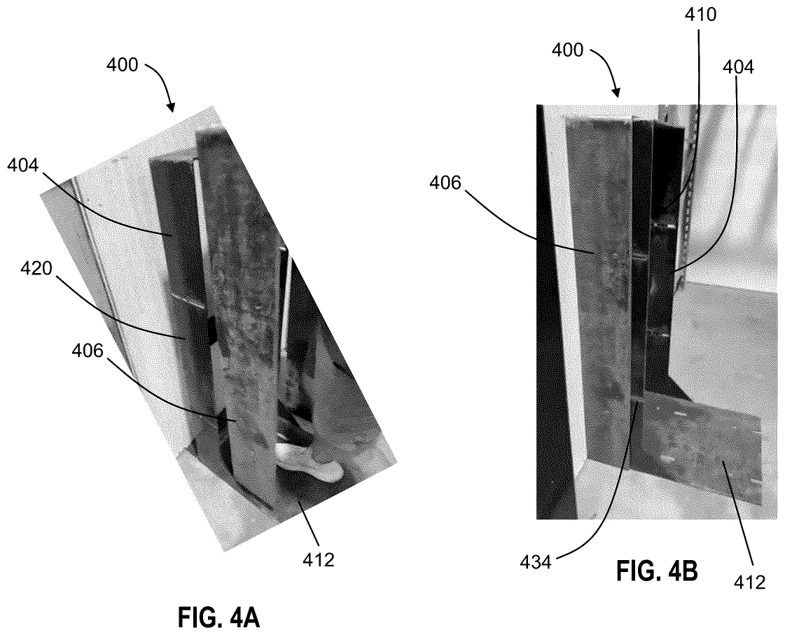

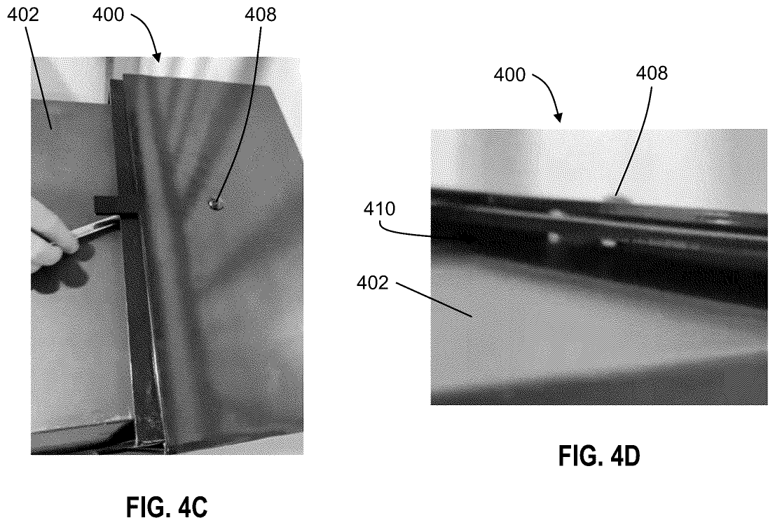

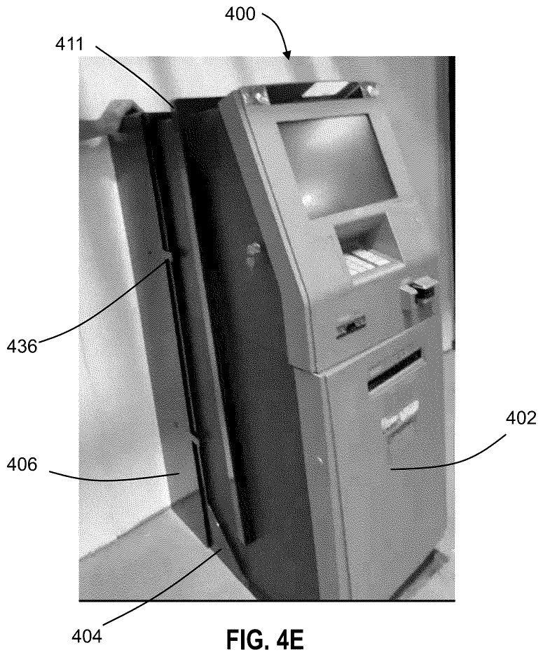

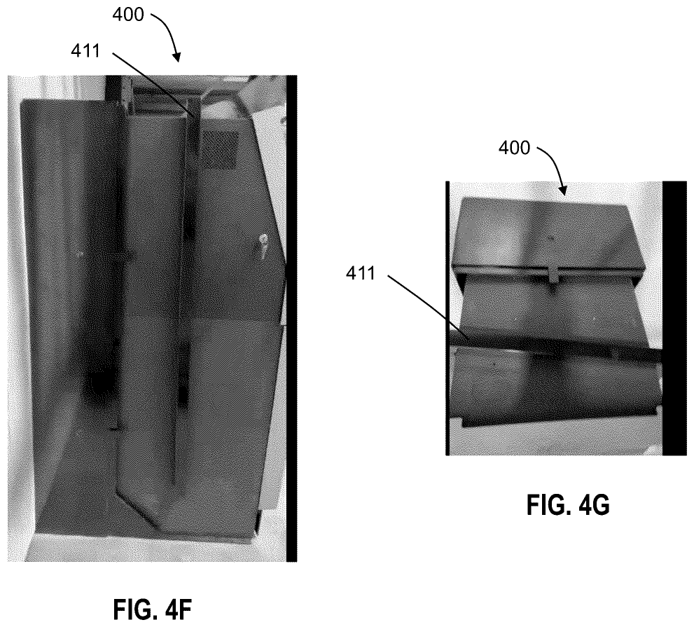

The locking element 108 may be configured to secure the sleeve 106 in position with respect to the theft prevention structure 104 and the ATM 102. The locking element 108 may include a blind bolt or fastener that is not removable from one side, such as a square neck carriage bolt. This type of fastener is designed so that it cannot be loosened or removed from the exposed side, further enhancing security by preventing unauthorized access or tampering with the locking mechanism. For example, as shown in FIG. 4D, the nut of the bolt may be accessible from only within the gap region between the ATM and the theft prevention structure 104, which may further prevent inadvertent removal or tampering.

Referring to FIGS. 1E-1F, the sleeve 106 may be configured to move relative to the theft prevention structure 104 along the longitudinal direction 122 (e.g., forward and rearward relative to a front face of the ATM). In such embodiments, the theft prevention structure 104, including any one or combination of the top wall 118 and the side walls 120a, 120b, may define one or more elongated apertures, shown as slots 134 extending along the longitudinal direction 122. In such implementations, the sleeve 106 may define a lock member opening 123 (e.g., a hole extending through the sleeve 106) that is aligned with a respective one of the slots 134 when the sleeve 106 is disposed on (e.g., over) the theft prevention structure 104. The locking element 108 may include a second fastener that extends through the lock member opening 123 and the respective one of the slots 134.

In some embodiments, the sleeve 106 also includes slot guides (e.g., guide protrusions) that protrude toward the theft prevention structure 104. The slot guides may be aligned with respective ones of the slots 134 and can facilitate sliding engagement between the sleeve 106 and the theft prevention structure 104.

Referring to FIGS. 1B-1C, in some embodiments, the sleeve 106 may include concealing features, shown as tabs 136, protruding away from an edge of the sleeve 106 along the longitudinal direction 122. The tabs 136 are aligned with respective ones of the slots 134 of the theft prevention structure 104. The tabs 136 are configured to conceal portions of respective ones of the slots 134 when the sleeve 106 is positioned against the wall. A length of the tabs 136 along the longitudinal direction 122 may correspond with a length of the slots 134 to ensure that the tabs 136 fully cover the slots 134 when the sleeve 106 is positioned at a rearmost position relative to the theft prevention structure 104 (see also FIGS. 1E-1F).

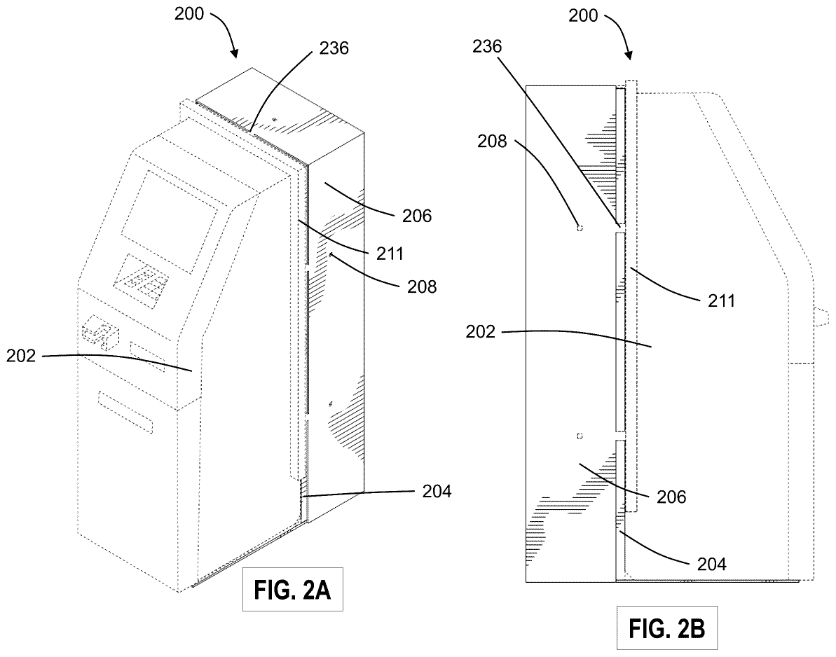

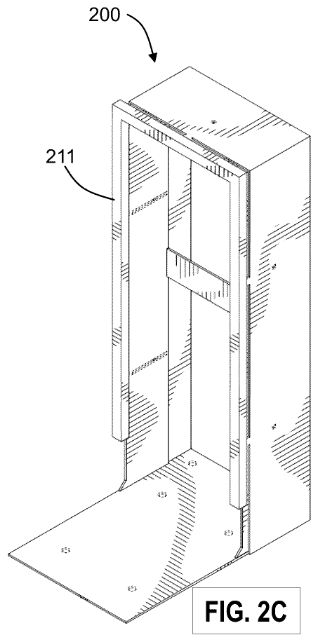

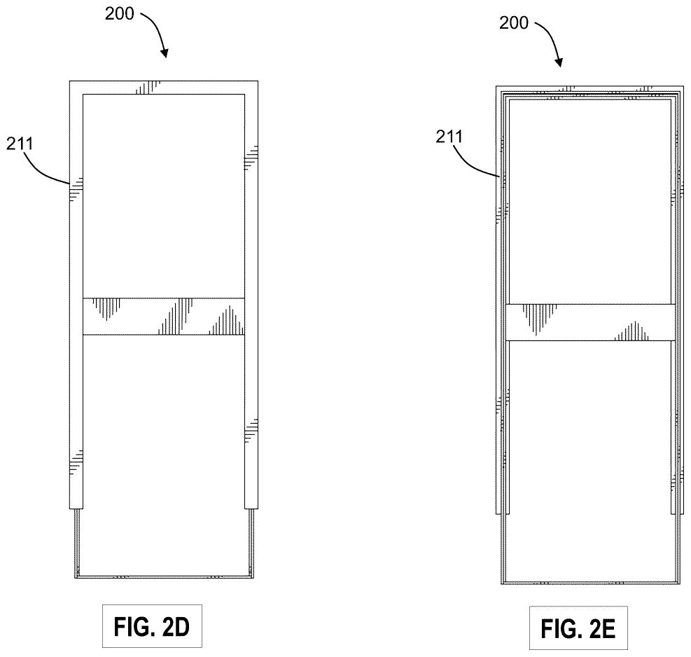

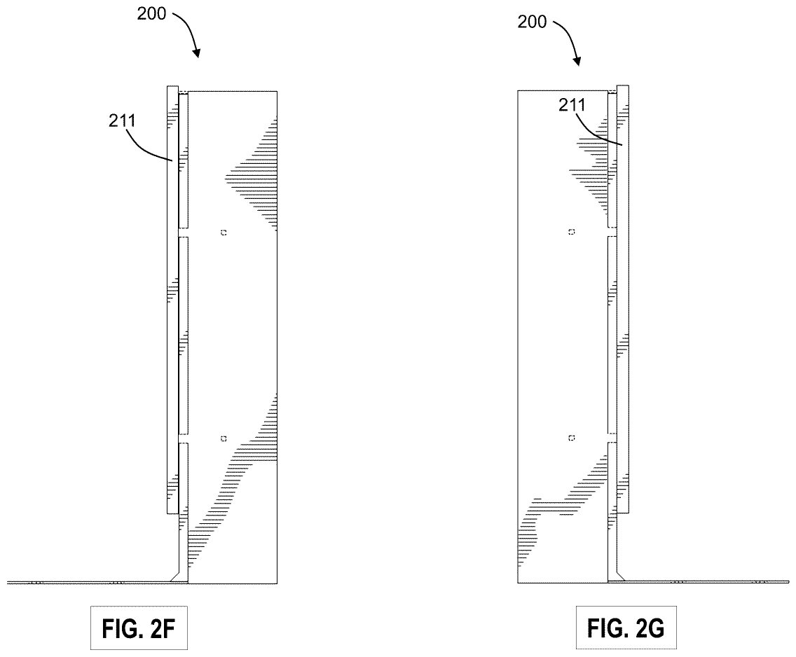

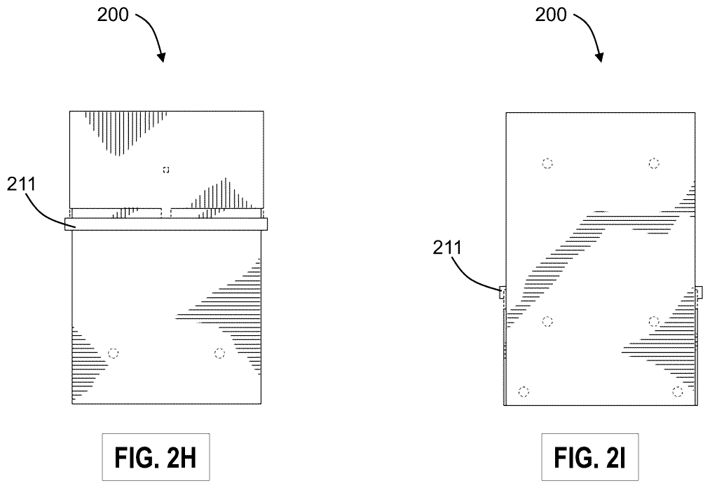

Referring to FIGS. 2A-2I, another embodiment of a theft prevention enclosure system 200 for an ATM 202 is shown. As shown in FIGS. 2A-2B, the theft prevention enclosure system 200 includes a theft prevention structure 204, a sleeve 206, a locking element 208, and a cover trim 211. The theft prevention structure 204, the sleeve 206, and the locking element 208 may be the same as or similar to the theft prevention structure 104, the sleeve 106, and the locking element 108 described with reference to FIGS. 1A-1J.

The cover trim 211 is configured to conceal at least a portion of the theft prevention structure 204, the sleeve 206, and the locking element 208. The cover trim 211, which may also be referred to as an outer trim or forward trim, is configured to enhance the security and aesthetic continuity of the theft prevention enclosure system 200. In some embodiments, and as shown, the cover trim 211 extends along the forward edge of the sleeve 206 and/or the theft prevention structure 204, engaging with one, or a combination of, the theft prevention structure 204 and the tabs 236 protruding from the sleeve 206. The cover trim 211 is configured to conceal one, or a combination of, the tabs 236 and a gap between the theft prevention structure 204 and the ATM 202. This concealment can not only reduce visible access points that could be exploited for tampering, but also provides a finished, seamless appearance to the installation, further supporting the integrity of the theft prevention enclosure system 200.

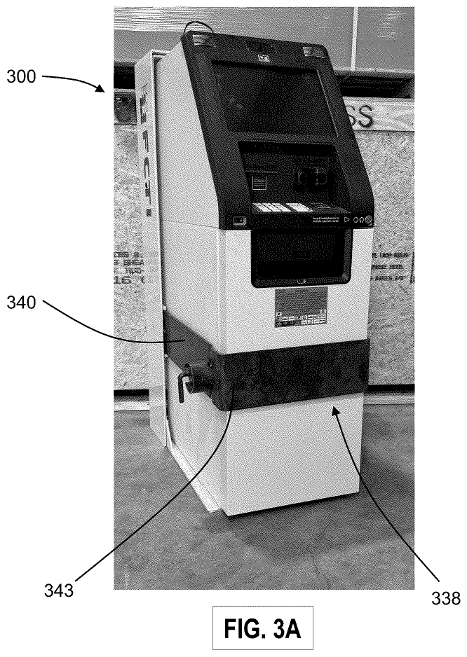

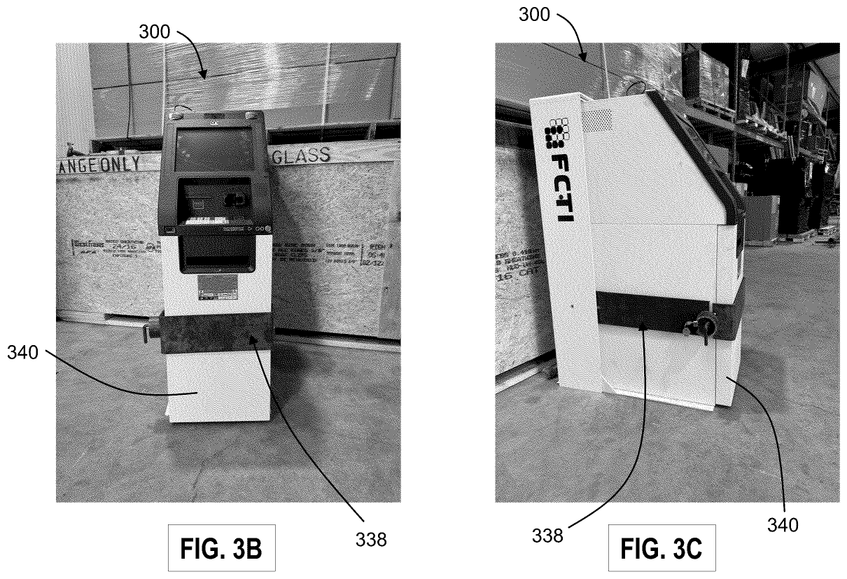

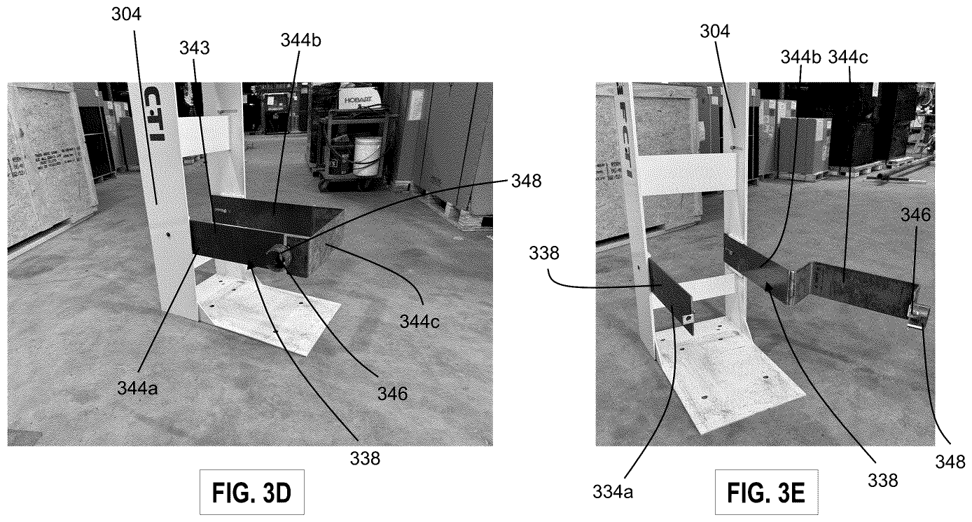

Referring to FIGS. 3A-3C, an illustrative theft prevention enclosure system 300 is shown inclusive of a retaining belt assembly 338 that is configured to prevent access to a service cover 340 of an ATM 302 (e.g., a maintenance cover, a cash vault door, cash cassette access door). In some embodiments, the retaining belt assembly 338 provides a secondary locking mechanism that supplements the native lock installed directly onto the service cover 340. In such embodiments, the retaining belt assembly 338 can provide redundancy to further reduce the risk of access to internal components of the ATM 302 (e.g., to a cash cassette containing currency) through the service cover 340. In some embodiments, the retaining belt assembly 338 is a standalone locking mechanism for the service cover 340.

Referring to FIGS. 3D-3E, the retaining belt assembly 338 includes a retaining belt structure 343 (e.g., framework) that extends from and/or connects to a theft prevention structure 304 (e.g., a housing) of the theft prevention enclosure system 300 on both sides of the ATM and around a forward end of the ATM. In some embodiments, and as shown, the retaining belt structure 343 encompasses/surrounds the ATM on at least three sides thereof. As shown in FIG. 3A, the retaining belt structure 343 encompasses the service cover 340 and secures the service cover 340 in position with respect to the theft prevention structure 304.

In some embodiments, the retaining belt structure 343 may include a plurality of elongated panels 344a, 344b, 344c (collectively 344) that together define a rectangular profile when viewed from above the ATM 302. The elongated panels 344 may include a first pair of panels 344a, 344b extending from the theft prevention structure 304 in substantially parallel orientation with respect to one another, and a second panel 344c extending between and joining an outer end (e.g., a distal end, a free end, a second ends) of each panel of the first pair of panels 344a, 344b (e.g., from a distal end of a first panel 344a of the first pair of panels to a distal end of a second panel 344b of the first pair of panels). The panels 344 may be made from a metallic material, such as an iron alloy, a stainless steel alloy, or another durable, cut and damage-resistant material.

A proximal end of each of the first pair of panels 344a, 344b is coupled to a respective one of the vertical side walls of the theft prevention structure 304 and engaged with an inner surface of the side walls of the theft prevention structure 304 that face towards one another. In some embodiments, at least one of the first pair of panels 344a, 344b engages a recessed area defined by a respective sidewall of the theft prevention structure 304, which can facilitate vertical alignment of the retaining belt assembly 338 relative to the theft prevention structure 304.

In some embodiments, the retaining belt assembly 338 includes carriage bolts or another type of blind end fastener (e.g., a fastener that cannot be engaged by a wrench or another tool external to the housing) that couple each of the first pair of panels 344a, 344b to a respective one of the side walls of the theft prevention structure 304. Such an arrangement can prevent unauthorized persons from removing the retaining belt assembly 338 from the theft prevention structure 304.

In some embodiments, carriage bolts engage respective panels of the first pair of panels 344a, 344b through an elongated slot that is defined by each of the first pair of panels 344a, 344b (e.g., an elongated slot at the proximal end of the panels). Such an arrangement can enable adjustment of the distance between the second panel 344c and the theft prevention structure 304, and/or an overall dimension of the ATM that can be accommodated by the retaining belt assembly 338. In other embodiments, and as shown, the first pair of panels 344a, 344b may be welded or otherwise permanently coupled to the theft prevention structure 304.

Referring to FIGS. 3D-3E, the retaining belt (e.g., the second panel 344c) is repositionable between a first position (e.g., a locked position) in which the second panel 344c is secured to both of the first pair of panels 344a, 344b at opposing ends thereof, and a second position (e.g., an unlocked position) that is rotationally offset from the locked position. In some embodiments, and as shown, the second panel 344c is rotatably coupled to a respective one of the first pair of panels 344a, 344b (e.g., at a first end of the second panel 344c) to enable the second panel 344c to rotate away from the service cover of the ATM in the unlocked position.

In some embodiments, the retaining belt assembly 338 may also include a locking feature 346 (e.g., a lock) that is configured to couple the second panel 344c (e.g., a second end of the second panel 344c opposite from the first end) to one of the first pair of panels 344a, 344b. The locking feature 346 may include a padlock or another type of mechanical or electromechanical lock. In some embodiments, and as shown, the retaining belt assembly 338 also includes a lock enclosure 348 that at least partially surrounds the locking feature 346 and prevents unauthorized access to the locking feature 346.

It should be appreciated that the shape, arrangement, and/or number of retaining belt assemblies 338 used with the theft prevention structure 304 may be different in various embodiments. For example, in some embodiments, the retaining belt assembly may include a retaining belt structure that extends across the service cover 340 in a different direction, such as from a base of the theft prevention structure 304 so that the retaining belt extends at least partially vertically from the base. The position and/or arrangement of the locking feature 346 may also be different in various embodiments. For example, the locking feature may be disposed on a central area of the second panel 344c, between two panel sections of the second panel 344c that are rotatably coupled to respective ones of the first pair of panels 344a, 344b. In other embodiments, the locking feature 346 may be configured to secure the one or more panel sections directly to the ATM (e.g., to the service cover 340).

It should be understood that the structure of the theft prevention structure, sleeve, and/or retaining belt along with the functionality thereof may be integrated in part or in whole into a housing of the ATM. For example, a sleeve or other structural member that is able to slide, rotate, or otherwise enable a gap between a rear housing of the ATM and wall disposed behind the ATM to be close off to minimize or prevent access to the rear housing of the ATM. By limiting or preventing access to the back of the ATM, the ability for a thief to place a chain or other component behind or around the ATM may be difficult enough to deter or prevent theft of the ATM. Additionally, the retaining belt assembly may be integrated (e.g., bolted, welded, or otherwise integrated) with a service cover of the ATM, and may engage with a housing at least partially surrounding or supporting the ATM to increase the strength of the cover against tampering.

Referring to FIGS. 4A-4G, an illustrative method of installing an ATM 402 into an environment via a theft prevent enclosure system 400 is shown. The method includes: positioning a theft prevention structure 404 at a wall such that an security region defined by the theft prevention structure 404 faces away from the wall; inserting the ATM 402 into a security region 410 defined by the theft prevention structure 404 (e.g., through the security region 410 defined by the theft prevention structure 404 that extends through the theft prevention structure 404); securing the ATM and theft prevention structure 404 to a floor at which the ATM 402 and theft prevention structure 404 are positioned; and moving a sleeve 406 disposed over the theft prevention structure 404 relative to the theft prevention structure 404 such that the sleeve 406 engages the wall to substantially enclose a region between the ATM 402 and the wall, thereby limiting or preventing access to a rear side of the ATM 402.

With regard to FIG. 4A, the positioning the theft prevention structure 404 at the wall includes engaging a longitudinal end of a base 412 of the theft prevention structure 404 with the wall and such that at least one side wall 420 of the theft prevention structure 404 is spaced apart from the wall.

With regard to FIG. 4B, in some embodiments, the method further includes securing the sleeve 406 in position with respect to the theft prevention structure 404 by engaging a locking element 408 with both the theft prevention structure 404 and the sleeve 406. In the embodiment of FIG. 4B, the method includes placing the sleeve 406 over the theft prevention structure 404 to align slots of the theft prevention structure 404 with respective openings along the sleeve 406. The method may further include inserting locking elements, such as blind end bolts or another type of mechanical fastener, into the openings along the sleeve 406, so that a threaded end of the bolts extends through the theft prevention structure 404 (e.g., the slots), and threading nuts onto a threaded end of the bolts from inside the security region 410.

With regard to FIG. 4C, in some embodiments, inserting the ATM 402 includes positioning the ATM 402 at an intermediate position along the base within the security region. For example, the method may include engaging the ATM 402 with a support member that extends across an opening at a first longitudinal end (e.g., a rear end, a wall facing end) of the security region 410 (see also FIG. 4B).

In some embodiments, the method further includes securing the housing to the floor by inserting at least one fastening member through a base opening defined by the base of the theft prevention structure 404 and into the floor and/or the wall. The method may further include connecting the ATM to the environment via cords, plugs, etc. that extend from a rear of the ATM 402 and into an enclosed space between the security region 410 and the wall.

With regard to FIG. 4B, the method further includes repositioning the sleeve 406 (e.g., from a first position substantially aligned with the theft prevention structure 404 to a second position that extends rearward of the theft prevention structure 404) to conceal the enclosed space between the security region and the wall, such as by moving the sleeve 406 relative to the theft prevention structure 404 to readjust a position of a lock member opening of the sleeve 406 relative to the slot 434 defined by the theft prevention structure 404.

With regard to FIGS. 4C-4D, the method includes tightening the locking elements 408 such as by tightening nuts disposed in the region between the ATM 402 and the theft prevention structure 404 to secure the sleeve 406 in a cable/plug concealing position.

With regard to FIGS. 4E-4G, the method may also include engaging a cover trim 411 with tabs 436 of the sleeve 406 and/or a forward edge of the theft prevention structure 404 to conceal (i) at least a portion of a gap between the ATM 402 and the theft prevention structure 404, and/or (ii) the tabs 436. In some embodiments, the method includes pressing the cover trim 411 toward the theft prevention structure 404 to engage magnets within the cover trim 411, the sleeve 406, and/or the theft prevention structure 404 with one another (or with a ferromagnetic material of the cover trim 411, the sleeve 406, and/or the theft prevention structure 404).

In some embodiments, the method further includes coupling a retaining belt assembly to the theft prevention structure 404. In such embodiments, the method may further include wrapping a retaining belt structure (e.g., a panel section of the retaining belt structure) around a forward end of the ATM 402 (e.g., around a service cover of the ATM 402) to at least partially enclose the forward end of the ATM 402. In some embodiments, the method further includes locking the retaining belt structure in position over the forward end of the ATM 402 to prevent access to or opening of the service cover of the ATM 402.

The structure and arrangement of the theft prevention system, theft prevention structure, and method of installation of the theft prevention system as described with reference to certain embodiments herein should not be considered limiting. Various alternatives and combinations are possible without departing from the inventive principles described herein.

### Features

In an embodiment, the theft prevention enclosure system may include a theft prevention structure defining a security region sized to receive an automated teller machine (ATM) therein. A sleeve may be disposed on the theft prevention structure. A locking element may be used to lock the left prevention system. The theft prevention structure may include a base defining a base opening to enable a fastening member to extend through the base opening and into a floor on which the theft prevention structure is positioned. The sleeve and the theft prevention structure may together define an enclosed space that extends from the security region. The sleeve may be slidably engaged with the theft prevention structure such that movement of the sleeve relative to the theft prevention structure changes a volume of the enclosed space. The sleeve, when slidably positioned to be positioned against a wall of a structure behind the ATM, may limit or prevent access to a rear side of the ATM. The locking element may be configured to secure the sleeve in position with respect to the theft prevention structure.

The theft prevention structure may include a top wall and a pair of side walls extending between the base and the top wall. The pair of side walls may be spaced apart from a least one longitudinal end of the base.

The at least one sidewall of the pair of side walls may define a support member that extends at an angle from the at least one sidewall to the base.

A distance between the pair of side walls and a first longitudinal end of the base may be sized to accommodate a power connection for the ATM when the ATM is coupled to the theft prevention structure.

The base may define a plurality of openings disposed beneath or behind the ATM when engaged with the theft prevention structure and that are configured to facilitate mounting the theft prevention structure to the floor.

The sleeve may be configured to move relative to the theft prevention structure along a longitudinal direction. The theft prevention structure may define a slot extending along the longitudinal direction. The sleeve may define a lock member opening that is aligned with the slot when the sleeve is disposed over the theft prevention structure. The locking element may include a blind fastener that extends through the lock member opening and the slot.

The sleeve may define a tab protruding from an outer edge thereof along a longitudinal direction, where the tab is aligned with the slot.

The theft prevention structure may include a support member extending across the security region at a first longitudinal end of the theft prevention structure, and the support member is configured to prevent movement of the ATM into the enclosed space.

A height of the sleeve may be approximately the same as a height of the theft prevention structure.

The sleeve may be sized to substantially enclose an open region between the ATM and the wall of the structure behind the ATM.

The theft prevention enclosure system may further include a retaining belt assembly coupled to the theft prevention structure and extending forward of the theft prevention structure. The retaining belt assembly may be configured to wrap around a forward end of the ATM when the ATM is installed into the theft prevention structure.

Another embodiment relates to a theft prevention structure for an automated teller machine (ATM). The theft prevention structure includes: a base configured to support the ATM above a ground surface; a top wall, and a pair of side walls. The base may define at least one opening configured to receive a fastening member for anchoring the theft prevention structure to the ground surface or a rear wall. The pair of side walls may extend between the base and the top wall and may defining, with the base and the top wall, a security region sized to receive the ATM therein. The base may protrude from an outer edge of the pair of side walls along a longitudinal direction. At least one of the top wall and the pair of side walls may define a slot that extends along the longitudinal direction.

The theft prevention structure may further include a support member extending across the security region between the pair of side walls. The support member may be configured to engage the ATM to limit movement of the ATM past the security region.

The theft prevention structure may further include a retaining belt assembly coupled to the pair of side walls and extending forward of the security region. The retaining belt assembly may include a retaining belt movable between an unlocked position and a locked position to prevent access to a service cover of the ATM.

Another embodiment relates to a method of installing an automated teller machine. The method includes: positioning a housing at a wall such that an opening defined by the housing faces away from the wall; inserting the automated teller machine (ATM) through the opening and into an enclosed volume defined by the housing; securing the ATM and housing to a floor at which the ATM and housing are positioned; and moving a sleeve disposed over the housing relative to the housing such that the sleeve engages the wall to substantially enclose a region between the ATM and the wall, thereby limiting or preventing access to a rear side of the ATM.

With respect to the method of installing the theft prevention system, positioning the housing at the wall may include engaging a longitudinal end of a base of the housing with the wall and such that a sidewall of the housing is spaced apart from the wall.

The method may further include securing the sleeve in position with respect to the housing by engaging a locking element with both the housing and the sleeve.

Moving the sleeve relative to the housing may include moving a lock member opening of the sleeve across a slot defined by the housing.

Inserting the automated teller machine may include engaging the automated teller machine with a support member extending across the opening at a first longitudinal end of the housing.

Securing the housing to the floor may include inserting at least one fastening member through an opening defined by a base of the housing and into the floor.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the theft prevention enclosure system as shown in the various exemplary embodiments is illustrative only. Additionally, any element disclosed in one embodiment may be incorporated or utilized with any other embodiment disclosed herein. It should be appreciated that other elements of the various embodiments may be incorporated or utilized with any of the other embodiments disclosed herein.

What is claimed is:

1. A theft prevention enclosure system for an automated teller machine (ATM), the theft prevention enclosure system comprising:
a theft prevention structure defining a security region sized to receive an automated teller machine (ATM) therein, the theft prevention structure including a base defining a base opening to enable a fastening member to extend through the base opening and into a floor on which the theft prevention structure is positioned;
a sleeve disposed on the theft prevention structure, the sleeve and the theft prevention structure together defining an enclosed space that extends from the security region, the sleeve slidably engaged with the theft prevention structure such that movement of the sleeve relative to the theft prevention structure changes a volume of the enclosed space, the sleeve, when slidably positioned to be positioned against a wall of a structure behind the ATM, limiting or preventing access to a rear side of the ATM; and
a locking element configured to secure the sleeve in position with respect to the theft prevention structure.

2. The theft prevention enclosure system of claim 1, wherein the theft prevention structure further comprises:
a top wall; and
a pair of side walls extending between the base and the top wall, wherein the pair of side walls are spaced apart from a least one longitudinal end of the base.

3. The theft prevention enclosure system of claim 2, wherein at least one sidewall of the pair of side walls defines a support member that extends at an angle from the at least one sidewall to the base.

4. The theft prevention enclosure system of claim 2, wherein a distance between the pair of side walls and a first longitudinal end of the base is sized to accommodate a power connection for the ATM when the ATM is coupled to the theft prevention structure.

5. The theft prevention enclosure system of claim 1, wherein the base defines a plurality of openings disposed beneath or behind the ATM when engaged with the theft prevention structure and that are configured to facilitate mounting the theft prevention structure to the floor.

6. The theft prevention enclosure system of claim 1, wherein the sleeve is configured to move relative to the theft prevention structure along a longitudinal direction, the theft prevention structure defining a slot extending along the longitudinal direction, the sleeve defining a lock member opening that is aligned with the slot when the sleeve is disposed over the theft prevention structure, wherein the locking element comprises a blind fastener that extends through the lock member opening and the slot.

7. The theft prevention enclosure system of claim 6, wherein the sleeve defines a tab protruding from an outer edge thereof along a longitudinal direction, the tab aligned with the slot.

8. The theft prevention enclosure system of claim 1, wherein the theft prevention structure comprises a support member extending across the security region at a first longitudinal end of the theft prevention structure, the support member configured to prevent movement of the ATM into the enclosed space.

9. The theft prevention enclosure system of claim 1, wherein a height of the sleeve is approximately the same as a height of the theft prevention structure.

10. The theft prevention enclosure system of claim 1, wherein the sleeve is sized to substantially enclose an open region between the ATM and the wall of the structure behind the ATM.

11. The theft prevention enclosure system of claim 1, further comprising a retaining belt assembly coupled to the theft prevention structure and extending forward of the theft prevention structure, the retaining belt assembly configured to wrap around a forward end of the ATM when the ATM is installed into the theft prevention structure.

12. A theft prevention structure for an automated teller machine (ATM), the theft prevention structure comprising:
a base configured to support the ATM above a ground surface, the base defining at least one opening configured to receive a fastening member for anchoring the theft prevention structure to the ground surface or a rear wall;
a top wall; and
a pair of side walls extending between the base and the top wall and defining, with the base and the top wall, a security region sized to receive the ATM therein, the base protruding from an outer edge of the pair of side walls along a longitudinal direction, at least one of the top wall and the pair of side walls defining a slot that extends along the longitudinal direction.

13. The theft prevention structure of claim 12, further comprising a support member extending across the security region between the pair of side walls, the support member configured to engage the ATM to limit movement of the ATM past the security region.

14. The theft prevention structure of claim 12, further comprising a retaining belt assembly coupled to the pair of side walls and extending forward of the security region, the retaining belt assembly including a retaining belt movable between an unlocked position and a locked position to prevent access to a service cover of the ATM.

15. A method of installing an automated teller machine, the method comprising:
positioning a housing at a wall such that an opening defined by the housing faces away from the wall;
inserting the automated teller machine (ATM) through the opening and into an enclosed volume defined by the housing;
securing the ATM and housing to a floor at which the ATM and housing are positioned; and
moving a sleeve disposed over the housing relative to the housing such that the sleeve engages the wall to substantially enclose a region between the ATM and the wall, thereby limiting or preventing access to a rear side of the ATM.

16. The method of claim 15, wherein positioning the housing at the wall comprises engaging a longitudinal end of a base of the housing with the wall and such that a sidewall of the housing is spaced apart from the wall.

17. The method of claim 15, further comprising securing the sleeve in position with respect to the housing by engaging a locking element with both the housing and the sleeve.

18. The method of claim 15, wherein moving the sleeve relative to the housing comprises moving a lock member opening of the sleeve across a slot defined by the housing.

19. The method of claim 15, wherein inserting the automated teller machine comprises engaging the automated teller machine with a support member extending across the opening at a first longitudinal end of the housing.

20. The method of claim 15, wherein securing the housing to the floor includes inserting at least one fastening member through an opening defined by a base of the housing and into the floor.
